(19) United States
(12) Patent Application Publication
(10) Pub. No.: US 2013/0013120 A1
(43) Pub. Date: Jan. 10, 2013

(54) INTELLIGENT ENERGY SYSTEM

(76) Inventor: Shey Sabripour, Austin, TX (US)

(21) Appl. No.: 13/345,698

(22) Filed: Jan. 7, 2012

Related U.S. Application Data
(60) Provisional application No. 61/431,202, filed on Jan. 10, 2011.

(51) Int. Cl. G06N 3/02

(52) U.S. Cl. 700/291

(57) ABSTRACT

An adaptive, Web-assisted energy management technology works harmoniously with geo-specific natural environments and human interactions. Adaptive algorithms of the technology increase a building's thermodynamic efficiency by simplifying and optimizing the occupant-equipment-environment interactions. Energy-using features of a building are connected and communicate via a neural net whereby AI facilitates an intelligent energy usage feedback system. A linguistic user interface enhances personal control of the system.

### CROSS REFERENCE TO RELATED APPLICATIONS

This application relates to, claims the benefit of and priority from co-pending provisional U.S. patent application Ser. No. 61/431,202, of the same title, filed Jan. 10, 2011, the disclosure of which is incorporated herein as if set forth in full.

### TECHNICAL FIELD

This disclosure relates generally to efficient energy usage and more particularly to an intelligent energy system for suit for dwellings and workplaces.

### BACKGROUND

Current techniques used to provide human comfort in buildings are highly inefficient and utilize energy conversion process-controls that, though optimized at the individual component level, are not optimized at the system level. Worse yet, these systems become more inefficient when the highly dynamic and subjective interaction with human occupants occur. Home automation systems-be they simple programmable wall thermostats or sophisticated load analysis, occupancy-use, or smart-grid systems-cannot result in energy savings unless they are actually used effectively by the occupants.

### Problem to be Solved

According to the Department of Energy, buildings consume more than 40 quadrillion BTUs (quads) (Energy, 2011) per year, accounting for nearly 40 percent of energy use in the U.S. However, the actual energy needed to maintain human comfort and to provide other energy needs, such as entertainment, lighting, computing, cooking etc., is a fraction of this energy demand, leaving the majority to waste and inefficient production, distribution, and use. Far more energy is used in our buildings than is actually needed to meet our comfort needs. This energy is more closely related to the size of a building rather than the number of occupants or their energy needs to be comfortable.

More than 65 percent of a building load is used for heating, cooling, domestic hot water, and lighting. Our research indicates that this amount of energy can be reduced by at least 50 percent if building subsystems can better affect occupant comfort rather than the average ambient temperature of a building's air mass. More specifically, nearly 50 percent of thermal comfort is achieved through radiation rather than convection or conduction, yet the majority of building thermostats only measure and control ambient air temperature (FIG. 2).

Newer thermostats measure humidity, but only as a set-point static control. Humidity, and its associated latent heat play an important role in our perceived comfort, yet it is not in the closed-loop part of a comfort system. This is why people constantly adjust the thermostat temperature depending on the season and other indoor/outdoor environmental conditions. Accordingly, and often unnecessarily, HVAC equipment responds by rapidly changing the massive volume of air that surrounds us.

The primary objective of the work to be undertaken within this proposed project is to scientifically demonstrate that dynamically controlled algorithms can be effectively used to bridge the gap between subjective human comfort parameters (FIG. 3) and numeric computer linguistic interpretations needed to optimize equipment performance in building systems, thus resulting in significant energy savings. The advancement in scientific understanding from this research in the energy management field will be game changing.

Consider a typical building as a controlled thermodynamic system being Open (i.e., Mass, Work and Heat are transferred into and out of the system) and the desired output being subjective, dynamic, and time variant-depending upon variables that often cannot be accurately measured.

Existing home automation and energy management systems efficiently control individual components of a building's HVAC system, but they require deterministic and discrete input variables, and thus fall short of optimizing the desired output, i.e., occupant comfort at maximum efficiency. Altumaxis proposes a control technology that achieves optimization over time, from its interactions with the occupants and the environment (FIG. 4).

Traditional discrete logic control used in devices such as wall-mounted thermostats is replaced with an easy-to-use linguistic logic thermostat system. Use of this system requires a simple human interface called Comfort Touch™ (FIG. 5.) When household occupants adjust their comfort level using the touch screen dial, the system uses previously learned parameters from occupant interactions, compares them to reference-optimized systems developed over time from similar micro- and macro-climate environments, and provides output to home subsystems such as HVAC, lighting, windows, zone damper vents, etc.

The present disclosure provides an adaptive, Web-assisted energy management technology that works harmoniously with geo-specific natural environments and human interactions. Adaptive algorithms of the system increase a building's thermodynamic efficiency by simplifying and optimizing the occupant-equipment-environment interactions

### SUMMARY

How Does the Intelligent Energy System Work? Every aspect of our proposed system is designed to solve issues that current technologies on the market fail to address.

Altumaxis sensors are wireless, peel-and-stick devices for simple installation and operation. To make them even more effective, they harvest energy from ambient light to eliminate the need for batteries (FIG. 1). Our sensor is the only system that uses a patent pending linguistic human interface called Comfort Touch™, setting us apart from our competitors by keeping the human comfort in the control loop.

The simple touch screen only requires the user to answer the question “are you comfortable?” Users touch the screen to indicate whether the room is too hot, too cold, too bright or too dark, or comfortable; that's it. No other interaction is required. The system continuously monitors parameters such as temperature, humidity, radiant environment temperature, ambient light level, light color (thus source), and occupancy; and transmits the result through a wireless gateway to the Altumaxis web server where the Intelligent Energy Engine resides. We designed our gateway to be wireless, plug-and-play and interoperable with numerous OEM systems including ZigBee and other protocols. The heart of the system, called the Intelligent Energy Engine, is a cloud-based adaptive AI algorithm, so that it is always improving to keep the maintenance and upkeep at the point-of-use low. The proprietary algorithm is a key differentiator of our system. It continuously learns and optimizes the comfort and energy efficiency parameters fed back from users, compares individual building data with reference systems developed over time from similar micro- and macro-climate environments, and provides output to the building subsystems such as HVAC, lighting, windows, zone damper vents, etc. Since the entire system is wirelessly connected, even the firmware on our sensors may be updated if new, more effective user interfaces are required and to make the entire system seamless. We have designed the closed loop firmware/software system to be able to keep the sensors, gateway and the cloud algorithm always synchronized.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is the Comfort Touch panel which uses Linguistic Interface and is energy harvesting for low maintenance.

FIG. 2 Majority of home thermostats control ambient air temperature, not particularly relevant to human comfort.

FIG. 3 Human Comfort Factors are Highly Subjective, Dynamic and Multivariable.

FIG. 4 Altumaxis Intelligent Energy System is a Multivariable Adaptive Control Algorithm based on Numerous Comfort Factors Affecting the Entire System.

FIG. 5 Comfort Touch™, Wireless sensors measure ambient temperature, humidity, mean radiant temperature, occupancy, and ambient light level and color profile.

FIG. 6 is a graph illustrating Heat Loss Factors from the Human Body.

FIG. 7 Room-by-room multi variable thermal analysis model keeping human comfort in the loop.

FIG. 8 illustrates a Typical Psychrometric Chart embedded in our Intelligent Energy Engine.

FIG. 9 is a cartoon that illustrates example of Entropy Equations.

FIG. 10 illustrates exemplary Shortcomings of a Typical Thermostat to Predict Thermal Lag.

FIG. 11 depicts an Overview of our Neural Net Intelligent Energy Engine.

FIG. 12 is a schematic illustration of a Complete Intelligent Energy System of the present disclosure.

FIG. 13 is a schematic illustration of adaptive feedback in an intelligent energy system of the present disclosure.

FIG. 14 is an illustration of a Net Zero Residence of the present disclosure.

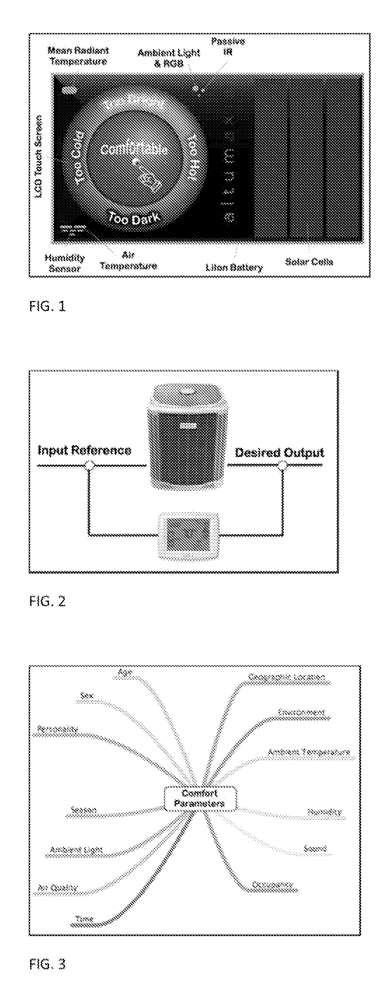

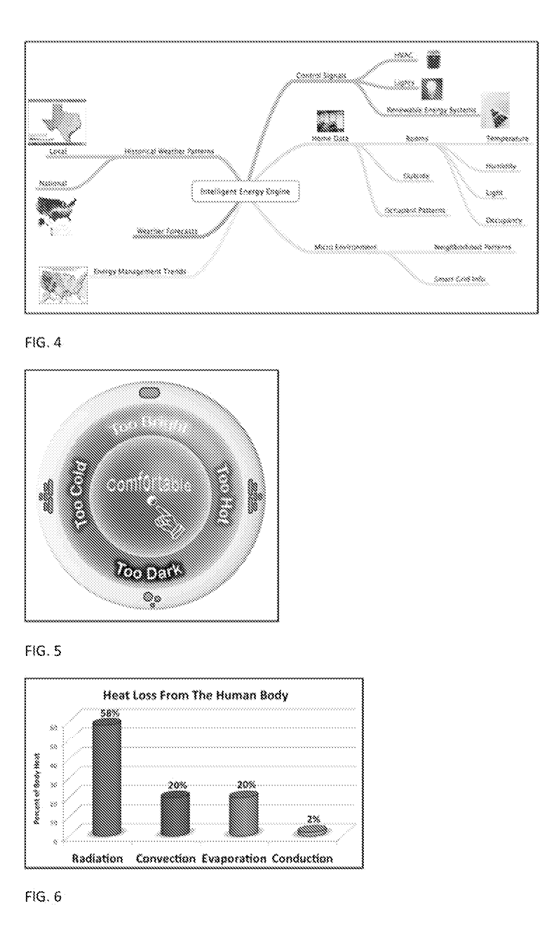

### DETAILED DESCRIPTION

To affect the net consumption of energy without sacrificing building comfort, three components need to be addressed:

Better Buildings: Designing and retrofitting better buildings to be inherently (passively) more efficient, better insulation, less infiltration, more thermal mass etc.

Better Equipment: Utilizing more efficient energy conversion subsystems such as Ground and Air Source Heat Pumps and Hybrid Domestic Hot Water systems, LED Lighting, energy recovery systems, etc.

Better Control: Smart thermal and energy management of buildings to manage load profiles and increase the thermodynamic efficiency of building energy conversion subsystems such as the HVAC.

Yet another home automation system? No, although significant effort has been expended in the field of smart-grid and smart-homes. Many companies such as Lutron, SAVANT, Control 4, GE and others promote sophisticated building automation hardware and software systems to address energy efficiency. However, close examination of most residential or commercial buildings clearly indicates that these systems are not widely installed (less than 1% market penetration) (Parks Associates, 2006) and/or if they are installed, rarely used in the long run.

Building automation systems must be used pervasively if they are to positively affect energy consumption. For example, even simple programmable home thermostats are primarily used as up/down permanent-hold temperature controllers. Using the setback feature alone, could reduce heating and air conditioning loads by as much as 30 percent (see a typical Honeywell thermostat manual). The significant reason for the lack of use, however, is called user-fatigue or complacency. Many of us have experienced or ignored blinking LEDs on various home appliances which is a testament to the issue that programming-upkeep of various household appliances is not a task most consumers are willing to perform, regardless of how impactful the results may be. Consumers use systems that only require minimal interaction, such as television remote controls or light switches.

Furthermore, the average setback temperature suggested in an owner's manual is too broad and insufficient to address the unique needs of typical buildings with a multitude of construction techniques and inherently different thermal mass and insulation properties. The recommended average setback temperature helps, but does not address the widely varying conditions of building environments. Worse yet, factors that affect human comfort are far more sophisticated and depend on much more data than just the ambient dry-bulb temperature measured by our thermostats.

The majority of our heating and cooling comfort comes from the radiation interchange to our surrounding thermal masses (FIG. 6). That measurement is not available in our current wall thermostats. Also, other parameters, such as time of the year, humidity, air velocity, and even ambient light, affects our overall feeling of comfort. Data for overall parameters that make humans comfortable have been extensively researched and published by the American Society of Heating, Refrigerating and Air Conditioning Engineers (ASHRAE) and others. Numerous Psychrometric charts have been published defining human comfort by specific regions and geographical locations. The problem is how to bridge the gap between the comfort data and our building HVAC equipment.

Why AI? AI technology is proven in pattern recognition applications and is used here in a transformative method. The technology addressed by the proposed research is not new and has been researched for many years in the field of electronics, software, and system controls.

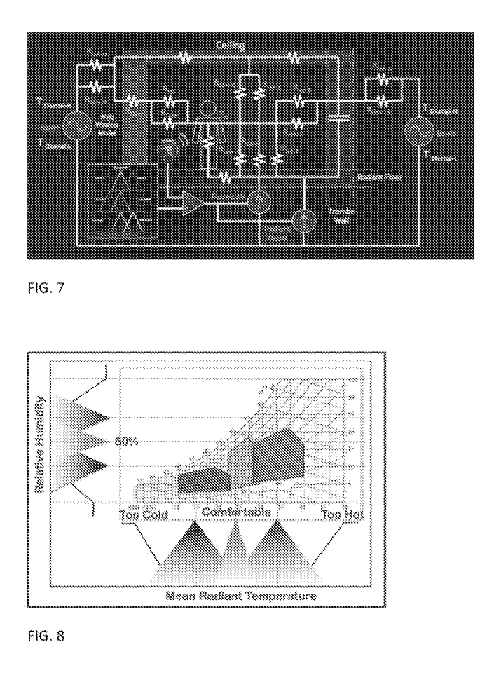

Products using this technology enable “natural voice” speech recognition, pattern extraction, and many other applications. Where applicable, especially when “fuzzy” or linguistic human variables are involved, AI technology is far superior and simpler than traditional model-based techniques. The proposed research project will show that AI technology is ideal for home energy management because the perception of human comfort is subjective, and energy component usage, optimization, and interconnectivity is dynamic, time varying, and multivariable. Complete understanding of the optimum solution to the automation and conservation of a complex thermodynamic system in convolution with its human interactions will no longer be an absolute necessity (FIGS. 7 and 8).

The planned project will demonstrate that our proposed AI control system can continuously optimize, modify, and adapt its responses over time to achieve the desired result, much like the human brain, thereby bridging the gap between subjective human perception and numeric computational precision.

Mathematical precision is easy. We know what makes machines work more efficiently and how to make them work better in a building system. The question is how to keep human comfort in the loop without making the system components operate at their low efficiency points. We also know that low entropy transfer of energy depends on the absolute temperature and the temperature differential at which heat is transferred. Considering a home as a thermodynamic system, an increase in internal energy equals heat added to the system minus work done by the system, shown in FIG. 9, equation (1), which can also be written as Equation (2) or, an increase in the internal energy of a system is its absolute temperature times net entropy change (or heat) minus pressure times the volume (or work). For example, a heat engine, such as that of an automobile, transfers heat from a hot source (combustion of fuel) to a heat sink (ambient air), thus producing work (moving the car). The maximum work efficiency of this cycle is determined by the Carnot efficiency given in Equation (3), which notes that maximum power output is gained when the temperature difference between the hot source and cold sink is at a maximum. Conversely, the reverse of a heat engine is a heat pump. Because heat always flows from a hot source to a cold sink, work is required to lift this heat from the cooler sink to a warmer source. This is the fundamental process by which refrigeration and air conditioning is performed and is denoted in Equation (4) of FIG. 9.

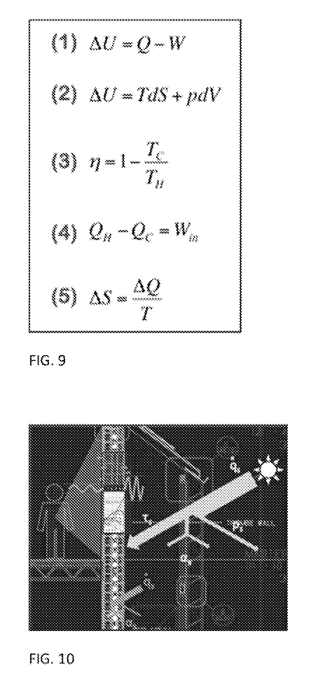

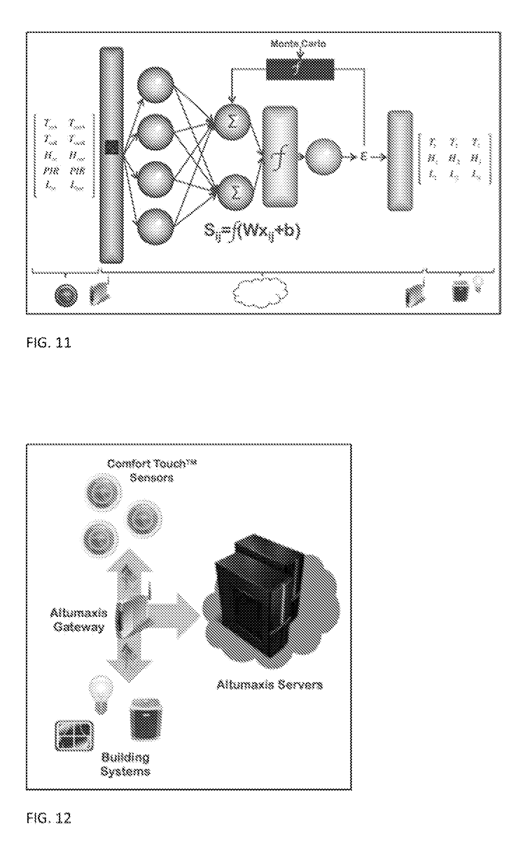

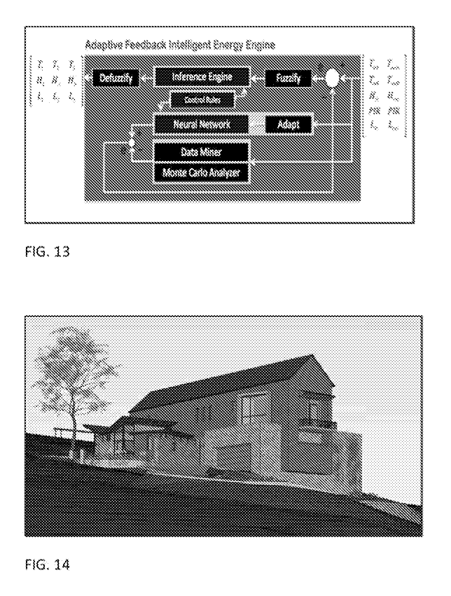

It is also evident from above equation that minimum work (maximum system efficiency) is achieved when the temperature differential between the cold sink and hot source is minimum. This is why heat pumps provide maximum coefficient of performance in moderate climates (i.e., heat lift is minimized). Entropy is system waste that cannot perform useful work, and it is defined by Equation (5), which indicates that change in entropy equals heat transferred divided by the absolute temperature in K. This equation indicates that transferring heat at a higher temperature and minimizing the thermal difference at which heat is transferred also minimizes entropy gain. This is the fundamental reason that a technique other than threshold based ambient temperature is needed to maximize the efficiency of a home or a building. To be specific what we need to control our building HVAC systems for peak performance depends on far more variables than a set point ambient temperature which trips the unit regardless of other variables. For example, a south-facing wall exposed to the winter sun (FIG. 10) is a good source of radiant heat and source of comfort even if the ambient air temperature of the room has been kept to a few degrees lower, before the occupants get home. To know when to turn the equipment on and off and to what exact temperature to set the thermostat, depends on a number of variables and is different from one building to the next. If we are to set the optimum turn on, turn off, compressor speed and other parameters for optimum system performance, we either need to know the exact thermal response conditions of a building or have a system that automatically learns its thermal environment by simple perturb-and-measure techniques. To make matters more complicated the optimum person-to-person comfort parameters are multivariable. Deterministic programmable systems cannot do the job unless they are designed specifically for each building. This is why we are designing our system to be adaptive and use multivariable control inputs. For an energy management system to fully optimize its performance, it must understand and adapt its operation to the actual conditions of its surrounding using static and dynamic parameters of a given building, and it must do so while maintaining its occupants comfort.

Why Neural Nets? As much as building-to-building variations in thermal mass, infiltration and exfiltration performance would make the optimum control of a building HVAC system complicated, numerous model-based proportional-integral-differential (PID) control approaches with proper input variables could effectively do the job. What pushes such a system over the edge is that human comfort also needs to be in the loop. We need to optimize the system-human-environment interactions to minimize wasted energy. Fuzzy/Neural-net control systems (FIG. 11) are better suited to capture human language, emotions, comfort, and other subjective variables, especially when they are dynamic, person-to-person specific, and time varying. Neural nets are excellent control algorithms when initiating data is based on human perception or is Fuzzy and furthermore, requires non-linear activation function to learn. The PI for this effort has conducted numerous side-by-side testing on various multivariable dynamic control algorithms for spacecraft use, and although successfully implemented PID controllers for those applications, believes that selected neural based system better addresses the dynamic control problem application when human comfort factors are involved and especially when the input variables are wildly dynamic with regards to geographic location, and may be cultural, temporal, etc.

In addition to the foregoing embodiments, the present disclosure provides programs stored on machine readable medium to operate computers and devices according to the principles of the present disclosure. Machine readable media include, but are not limited to, magnetic storage medium (e.g., hard disk drives, floppy disks, tape, etc.), optical storage (CD-ROMs, optical disks, etc.), and volatile and non-volatile memory devices (e.g., EEPROMs, ROMs, PROMs, RAMS, DRAMs, SRAMs, firmware, programmable logic, etc.). Furthermore, machine readable media include transmission media (network transmission line, wireless transmission media, signals propagating through space, radio waves, infrared signals, etc.) and server memories. Moreover, machine readable media includes many other types of memory too numerous for practical listing herein, existing and future types of media incorporating similar functionally as incorporate in the foregoing exemplary types of machine readable media, and any combinations thereof. The programs and applications stored on the machine readable media in turn include one or more machine executable instructions which are read by the various devices and executed. Each of these instructions causes the executing device to perform the functions coded or otherwise documented in it. Of course, the programs can take many different forms such as applications, operating systems, Perl scripts, JAVA applets, C programs, compilable (or compiled) programs, interpretable (or interpreted) programs, natural language programs, assembly language programs, higher order programs, embedded programs, and many other existing and future forms which provide similar functionality as the foregoing examples, and any combinations thereof.

Many modifications and other embodiments of the systems described herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for the efficient usage of energy in a dwelling having a plurality of energy using features, the system comprising a neural net by which the features communicate to provide an intelligent energy usage feedback system.

2. The system of claim 1, further comprising a linguistic user interface.

3. The system of claim 1, wherein the neural net supports AI to provide the intelligent energy usage feedback system.
